(19) United States
(12) Patent Application Publication
(10) Pub. No.: US 2026/0143508 A1
(43) Pub. Date: May 21, 2026

(54) CHANNEL MAP UPDATE (CMU) IN AN ACCESS POINT (AP) SYNCHRONIZATION SYSTEM

(71) Applicant: QUALCOMM Incorporated, San Diego, CA (US)

(72) Inventors: Xiuzhuo SHANG, Shanghai (CN); Nicolas GRAUBE, Cambridge (GB); Jie ZHANG, Shanghai (CN); Douglas KOGAN, Bend, OR (US); Cheng JIANG, Shanghai (CN); Zhaoming YANG, Shanghai (CN); Zaiyong CHEN, Shanghai (CN); Zhuxian GU, Suzhou (CN); Zhengjinyang JIANG, Shanghai (CN); Tingting LIU, Cambridge (GB)

(21) Appl. No.: 19/125,276

(22) PCT Filed: Nov. 17, 2022
(86) PCT No.: PCT/CN2022/132463

§ 371 Date: Apr. 28, 2025

(51) Int. Cl. H04W 72/30; G09F 3/20; H04W 8/00; H04W 48/16

(52) U.S. Cl. CPC H04W 72/30; H04W 8/005; H04W 48/16; G09F 3/208

(57) ABSTRACT

Disclosed are systems, apparatuses, processes, and computer-readable media for wireless communications. For example, an example of a process includes transmitting, by a network device to a network entity, a channel map update (CMU) request to update a channel map of the network device. The process can include receiving, by the network device from the network entity, CMU information for the network device based on the CMU request to update the channel map of the network device. The process can further include transmitting, by the network device, the CMU information to a group of wireless communication devices that are synchronized with the network device.

### FIELD OF THE DISCLOSURE

The present disclosure generally relates to wireless communications. For example, aspects of the present disclosure relate to a channel map update (CMU) in an access point (AP) synchronization system.

### BACKGROUND OF THE DISCLOSURE

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for wireless communications. According to at least one illustrative example, a method of wireless communication performed at a network device is provided. The method includes: transmitting, by the network device to a network entity, a channel map update (CMU) request to update a channel map of the network device; receiving, by the network device from the network entity, CMU information for the network device based on the CMU request to update the channel map of the network device; and transmitting, by the network device, the CMU information to a group of wireless communication devices that are synchronized with the network device.

In another illustrative example, a network device for wireless communication is provided. The network device includes at least one memory and at least one processor coupled to the at least one memory and configured to: output, for transmission to a network entity, a channel map update (CMU) request to update a channel map of the network device; receive, from the network entity, CMU information for the network device based on the CMU request to update the channel map of the network device; and output the CMU information for transmission to a group of wireless communication devices that are synchronized with the network device.

In another illustrative example, a non-transitory computer-readable medium is provided that include instructions that, when executed by at least one processor, cause the at least one processor to: output, for transmission to a network entity, a channel map update (CMU) request to update a channel map of the network device; receive, from the network entity, CMU information for the network device based on the CMU request to update the channel map of the network device; and output the CMU information for transmission to a group of wireless communication devices that are synchronized with the network device.

In another illustrative example, a network device for wireless communication is provided. The apparatus includes: means for transmitting, to a network entity, a channel map update (CMU) request to update a channel map of the network device; means for receiving, from the network entity, CMU information for the network device based on the CMU request to update the channel map of the network device; and means for transmitting the CMU information to a group of wireless communication devices that are synchronized with the network device.

illustrative example, a method of wireless communication performed at a network entity is provided. The method includes: receiving, by the network entity from a network device, a channel map update (CMU) request to update a channel map of the network device; determining, by the network entity, CMU information for the network device based on the CMU request; and transmitting, by the network entity, the CMU information for the network device to the network device and a plurality of network devices, wherein the network device is synchronized with a first group of wireless communication devices, and wherein each network device of the plurality of network devices is synchronized with a respective group of wireless communication devices.

In another illustrative example, a network entity for wireless communication is provided. The network entity includes at least one memory and at least one processor coupled to the at least one memory and configured to: receive, from a network device, a channel map update (CMU) request to update a channel map of the network device; determine CMU information for the network device based on the CMU request; and output the CMU information for the network device for transmission to the network device and a plurality of network devices, wherein the network device is synchronized with a first group of wireless communication devices, and wherein each network device of the plurality of network devices is synchronized with a respective group of wireless communication devices.

In another illustrative example, a non-transitory computer-readable medium is provided that include instructions that, when executed by at least one processor, cause the at least one processor to: receive, from a network device, a channel map update (CMU) request to update a channel map of the network device; determine CMU information for the network device based on the CMU request; and output the CMU information for the network device for transmission to the network device and a plurality of network devices, wherein the network device is synchronized with a first group of wireless communication devices, and wherein each network device of the plurality of network devices is synchronized with a respective group of wireless communication devices.

In another illustrative example, a network entity for wireless communication is provided. The apparatus includes: means for receiving, from a network device, a channel map update (CMU) request to update a channel map of the network device; means for determining CMU information for the network device based on the CMU request; and means for transmitting the CMU information for the network device to the network device and a plurality of network devices, wherein the network device is synchronized with a first group of wireless communication devices, and wherein each network device of the plurality of network devices is synchronized with a respective group of wireless communication devices.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a signaling diagram illustrating example communication transmissions, in accordance with some aspects of the present disclosure.

FIG. 4 is a diagram illustrating an example associated with discovery and synchronization between access points, in accordance with some aspects of the present disclosure.

FIG. 5 is a diagram illustrating example communication transmissions for updating a channel map of an access point, in accordance with some aspects of the present disclosure.

FIG. 6 is a diagram illustrating an example associated with synchronization of event counters between access points, in accordance with some aspects of the present disclosure.

FIG. 7 is a diagram illustrating an example of a portion of a periodic advertisement (PA) packet, in accordance with some aspects of the present disclosure.

FIG. 8 is a flow chart illustrating an example of a process for wireless communications at a network device, in accordance with some aspects of the present disclosure.

FIG. 9 is a flow chart illustrating an example of a process for wireless communications at a network entity, in accordance with some aspects of the present disclosure.

FIG. 10 is a block diagram illustrating an example of a computing system, which may be employed by the disclosed systems and techniques for a CMU in an AP synchronization system, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

A system may include one or more wireless communication devices that are controlled by a network entity. The network entity may communicate with the one or more wireless communication devices via one or more network devices. For example, an electronic shelf label (ESL) system may include one or more ESLs that are controlled by a management entity (ME). To facilitate control by the management entity, each ESL may have a wireless connection (e.g., a BLUETOOTH® Low Energy (BLE) connection or other connection) to an access point (AP) that is communicatively connected to the management entity (e.g., via the Internet, such as wirelessly, via an Ethernet connection, etc.). In some cases, commands from the management entity may be wirelessly transmitted to the ESLs by the access point. Responses or information from the ESLs may also be received by the access point and provided by the access point to the management entity. Each access point may have an associated channel map. A channel map is a listing of frequency channels to be utilized or, conversely, not to be utilized (e.g., in the context of modification of frequency hopping sequences) by an access point for communication, such as with the ESLs or other devices. While examples are described herein using ESLs as illustrative examples of wireless communication devices, a management entity as an example of a network entity, and access points as examples of network devices, the systems and techniques described herein are applicable to any type of system or network.

In some cases, an ESL may be physically moved to anew location. For example, the ESL may be moved from one location in a retail store (e.g., a particular shelf or a storage area) to a different location. Changing the location of the ESL may result in the ESL losing synchronization with (e.g., due to being out of range) a current access point for which the ESL is associated. Such a loss in synchronization may interrupt the management entity's ability to control the ESL and the ESL's ability to report to the management entity. After determining a network outage (e.g., caused by the loss of synchronization), the ESL may perform an onboarding procedure to reestablish synchronization with an access point. To perform the onboarding procedure, the ESL may transmit advertisement messages, receive a connection request from an in-range access point that detected the advertisement messages, and exchange messages with the access point (e.g., including the exchange of periodic advertisement synchronization transfer (PAST) information). The onboarding procedure may consume significant computing resources (e.g., processor resources, memory resources, and/or battery resources, among other examples) of the ESL and/or the access point, and frequent advertisement by one or more ESLs may result in spectral pollution on advertisement channels of the wireless network.

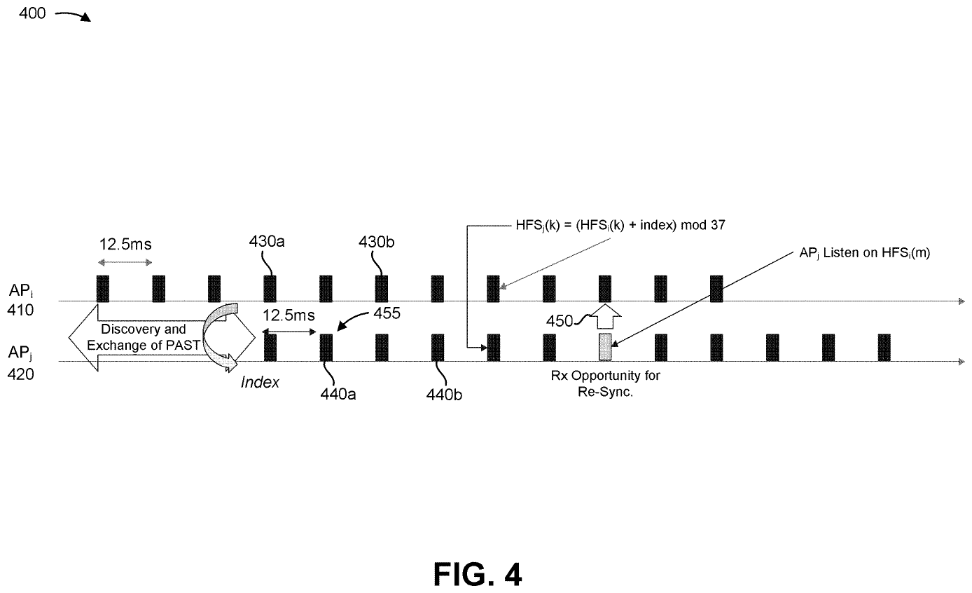

Currently, access point synchronization (e.g., described in detail in the description of FIG. 4) can enable discovery and synchronization of communication timings of multiple access points within an ESL system. In particular, periodic advertisement timings used by the multiple access points may be synchronized.

In access point synchronization, an ESL can have access to multiple access points. When an ESL is moved from one location to another location such that the ESL is out of range of its current associated access point, the ESL can identify an alternative access point that is within range of the ESL to associate with and jump on a periodic advertisement with multiple responses (PAwMR) train associated with that access point. However, in a typical environment (e.g., a large retail store, a warehouse, etc.), access points may be positioned in various different locations around the environment. As noted above, an access point is associated with a channel map that includes one or more RF channels that the access point can use for communicating with other devices, such as ESLs. The different access points positioned in the different locations around the environment may each have a different channel map because, for example, different areas of the environment (e.g., different departments of the store) may utilize different radio frequency (RF) frequency channels. The channel map of an access point can also be updated via a channel map update.

Furthermore, an ESL that has access to multiple access points may have access to a hopping frequency sequence (HFS) of each of the access points and/or may be able to derive the HFS of each access point from information stored by the ESL (e.g., information communicated to the ESL during on-boarding of the ESL with an access point). For example, the multiple access points may use different respective HFSs (e.g., offset from one another) to avoid interference among the multiple access points. A HFS can be generated through a pseudo-random sequence based on a number of parameters (e.g., four parameters). For instance, the pseudo-random sequence can generate a random number in the range [0 . . . 36](including all channels). A further set can then be imposed, such as by filtering out one or more channels that are outside of the channel map of an access point, and then substituting the filtered-out channels with one or more channels included in the channel map. Therefore, knowing the HFS (e.g., provided in the PAST information during on-boarding of an ESL) may need to be supplemented with the channel map. However, the HFS of an access point may not take into account a channel map of that access point or other access points, for example because the application of the channel map may be a post-HFS computation, which cannot be expressed a priori (e.g., due to the channel map evolving over time). An ESL may thus not be able to maintain knowledge of HFSs of access points when a channel map update occurs for each access point.

Systems and techniques are described herein for providing a channel map update (CMU) in an access point (AP) synchronization system, which may synchronize access points within an ESL system. For example, the systems and techniques can provide a solution to broadcast channel map information in an access point synchronization system such that all of the access points (and in some cases wireless communication devices, such as ESLs, associated with the access points) within an environment have knowledge of the particular channel maps associated with each of the access points within that environment.

Additional aspects of the present disclosure are described in more detail below.

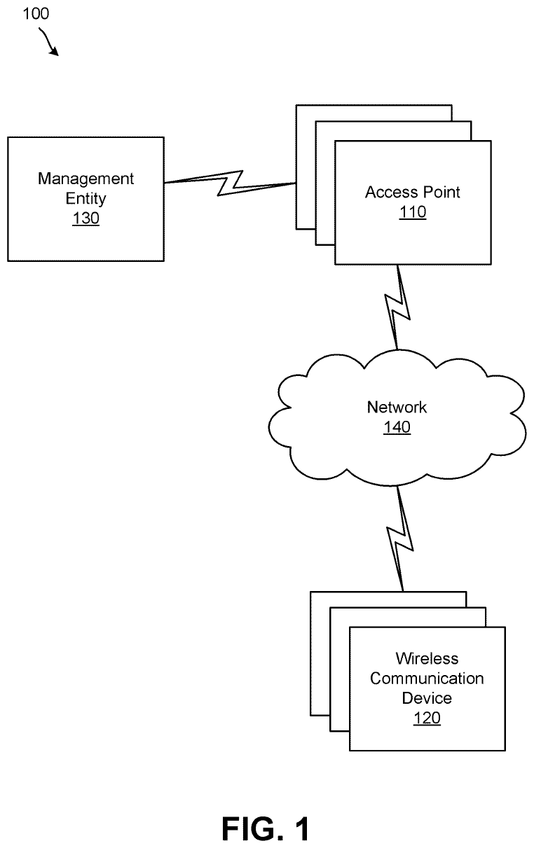

FIG. 1 is a diagram of an example environment 100 in which systems and/or methods described herein may be implemented. As shown in FIG. 1, the environment 100 may include at least one access point (AP) 110, at least one wireless communication device 120, a management entity (ME) 130, and a network 140. Devices of the environment 100 may interconnect via wired connections, wireless connections, or a combination of wired and wireless connections.

The access point 110 may include one or more devices capable receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

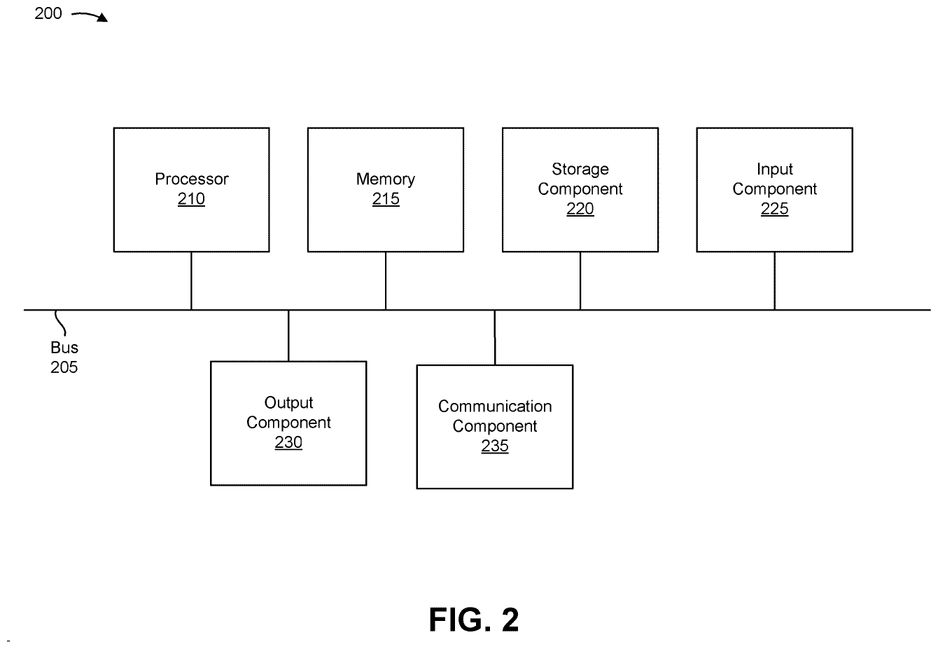

FIG. 2 is a diagram illustrating example components of a device 200, in accordance with the present disclosure. Device 200 may correspond to access point 110, wireless communication device 120, and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

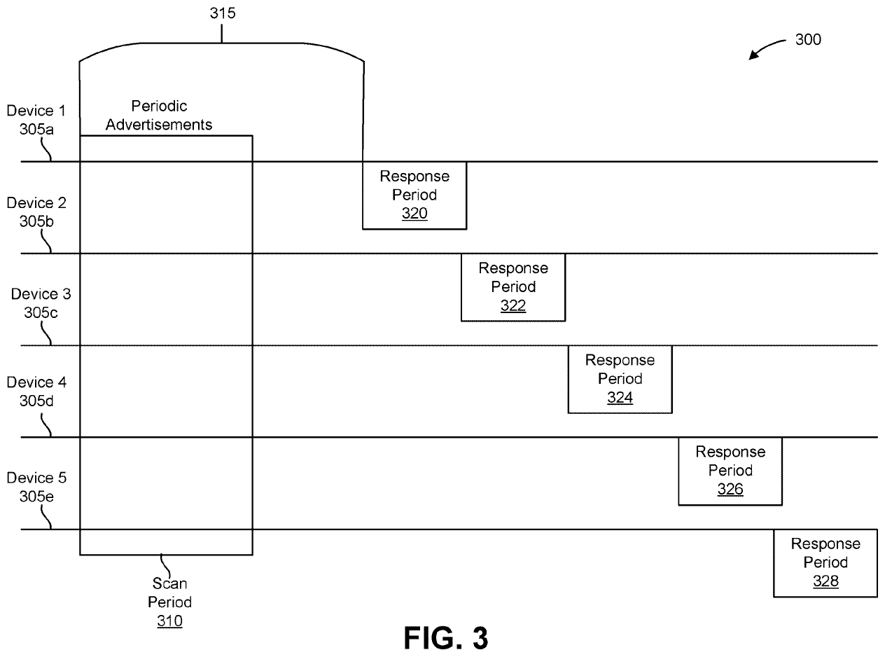

FIG. 3 is a signal timing diagram illustrating a portion of a communication between an access point (e.g., access point 110) and wireless communication devices 120 (e.g., ESLs). With reference to FIG. 1, the signal sequence illustrated in FIG. 3 may be implemented by one or more of the communication connections, access points 110, and/or wireless communication devices 120 of FIG. 1.

The devices (e.g., device 1 305a, device 2 305b, device 3 305c, device 4 305d, and device 5 305e) of FIG. 3 may be selected from wireless communication devices 120 of FIG. 1, and may each receive a periodic advertisement (PA) in a scan period 310. The scan period 310 may occur in regularly scheduled intervals and may be repeated periodically such that the devices (e.g., device 1 305a, device 2 305b, device 3 305c, device 4 305d, and device 5 305e) can awaken to scan for messages during this repeated scan period 310. An access point (e.g., access point 110 of FIG. 1) may provide periodic advertisements (PAs) via broadcast or multi-cast to the devices (e.g., device 1 305a, device 2 305b, device 3 305c, device 4 305d, and device 5 305e) in the scan period 310. For an access point (e.g., access point 110 of FIG. 1), the scan period 310 can be its primary transmission period. In some cases, the scan period 310 may not be a fixed time because the access point (e.g., access point 110 of FIG. 1) may send different lengths of data from the start of the scan period 310.

The transmission may include multiple advertisements in a train. One or more portions of the advertisements may be directed to one or more of the devices (e.g., device 1 305a, device 2 305b, device 3 305c, device 4 305d, and device 5 305e). The devices (e.g., device 1 305a, device 2 305b, device 3 305c, device 4 305d, and device 5 305e) may decode or filter the messages intended for each specific device and transmitted during the period when all devices are receiving. In this way, the devices (e.g., device 1 305a, device 2 305b, device 3 305c, device 4 305d, and device 5 305e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 305a, device 2 305b, device 3 305c, device 4 305d, and device 5 305e).

As illustrated, the devices (e.g., device 1 305a, device 2 305b, device 3 305c, device 4 305d, and device 5 305e) are each assigned a response period 320, 322, 324, 326, 328 in the time after the scan period 310. The first response period 320 may begin following an idle time 315 after the scan period 310, with the idle period being long enough to provide the transmitter device an opportunity to do other Bluetooth related activities. The assigned response periods may also be limited to or designate a particular frequency of the channels on which to respond. For example, in FIG. 3, device 1 305a is assigned response period 320, device 2 305b is assigned response period 322, device 3 305c is assigned response period 324, device 4 305d is assigned response period 326, and device 5 305e is assigned response period 328. The access point (e.g., access point 110 of FIG. 1) may store attributes of the devices (e.g., device 1 305a, device 2 305b, device 3 305c, device 4 305d, and device 5 305e), including whether a device is able to transmit or respond. The PA signaling followed by responses can be referred to as periodic advertisement with multiple responses (PAwMR).

For example, device 3 305c (e.g., wireless communication device 120 of FIG. 1) may be an ESL and may receive a price update in a PA from the access point (e.g., access point 110 of FIG. 1) in scan period 310. The PA received at device 3 305c may include a designated start time for the response period 324 or may include a schedule of response start times for devices including device 3 305c. The response by device 3 305c to the access point (e.g., access point 110 of FIG. 1) may include an acknowledgement, a status code, and/or other information such as battery life, received signal strength, and/or an error notification. The response by device 3 305c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 305a, device 2 305b, device 3 305c, device 4 305d, and device 5 305e) may use channels of the Bluetooth protocol.

A device (e.g., device 5 305e) that has been assigned a response period may not respond and may determine that it has nothing to signal. In other words, the devices (e.g., device 1 305a, device 2 305b, device 3 305c, device 4 305d, and device 5 305e) may determine what response, if any, is required and may or may not respond to a request sent from the access point (e.g., access point 110 of FIG. 1). The response periods 320, 322, 324, 326, 328 may be assigned based on a request for such a period in an open transmission time, the request being sent to the access point (e.g., access point 110 of FIG. 1). The response periods 320, 322, 324, 326, 328 may be assigned based on which devices have been requested by the access point (e.g., access point 110 of FIG. 1) to send data or acknowledgements. The PA messages and responses may be frequency-hopped, time synchronized channels, and/or extended channels of the advertising channels in Bluetooth.

FIG. 4 is a diagram illustrating an example of transmission timelines 400 associated with discovery and synchronization between access points (e.g., access points 110 of FIG. 1). As shown, example 300 includes access points (e.g., access points 110 of FIG. 1), shown as APᵢ 410 and APⱼ 420 on the transmission timelines 400. The access points APᵢ 410 and APⱼ 420 may be communicatively connected to a management entity (e.g., management entity 130 of FIG. 1). In some aspects, the access points and/or the management entity may be included in a wireless communication system, such as an ESL system. The wireless communication system may use a wireless communication technology, such as BLE.

As used herein, “transmission timing” or “periodic advertisement timing” may refer to a timing or schedule by which a device (e.g., an access point) transmits communications or periodic advertisements. For example, two devices that use (e.g., that are synchronized to) the same periodic advertisement timing may transmit periodic advertisements concurrently.

In one or more examples, during operation, a first access point AP1 (e.g., APᵢ 410) may transmit (e.g., broadcast) periodic advertisements (e.g., PAs 430a, 430b), such as a train of periodic advertisements. The periodic advertisements may be unidirectional broadcast messages. The first access point AP1 may transmit periodic advertisements in accordance with a PAwMR schedule. Moreover, the first access point AP1 may transmit the periodic advertisements using a first hopping frequency sequence (HFS). The first HFS may be an HFS configured for the first access point AP1 (e.g., if the first access point AP1 is not a follower of another access point), or the first HFS may be different from a reference HFS based at least in part on a first index value associated with (e.g., selected by) the first access point AP1.

A second access point AP2 (e.g., APⱼ 420) may detect at least one periodic advertisement broadcast from the first access point AP1 (e.g., by scanning known channels on which the first access point AP1 performs transmissions and/or by scanning, or taking a snapshot of, an entire band). That is, the second access point AP2 may discover the first access point AP1. In some aspects, the second access point AP2 may listen on one or more advertisement channels (e.g., legacy advertisement channels) to detect information that enables the second access point AP2 to follow and synchronize with the first access point AP1, thereby enabling the second access point AP2 to monitor for the periodic advertisement(s) (e.g., PAs 430a, 430b). In some aspects, the second access point AP2 may monitor for (e.g., listen for) and detect the periodic advertisement(s) prior to initiation of periodic advertisement transmissions by the second access point AP2 (which may be referred to as a “detect before proceed” policy). For example, in a boot sequence during starting (or re-starting) of the second access point AP2, the second access point AP2 may listen for periodic advertisements from other access points before starting periodic advertisement transmissions. In some aspects, access points (e.g., isolated access points), such as the second access point AP2, may periodically listen for periodic advertisements from neighboring access points.

Based on detecting a periodic advertisement from the first access point AP1, the second access point AP2 may transmit, and the first access point AP1 may receive, a message (e.g., an unsolicited message) to initiate a connection between the first access point AP1 and the second access point AP2. Following the connection, or as part of the connection procedure, the first access point AP1 may transmit, and the second access point AP2 may receive, a synchronization message. The synchronization message may identify the periodic advertisement timing (e.g., the PawMR schedule) used by the first access point AP1. For example, the synchronization message may include PAST information that indicates the periodic advertising timing used by the first access point AP1 (e.g., by indicating a time offset used by the first access point AP1). In some cases, the PAST information may also include the values of all of the parameters required for HFS computation as well as the channel map. In addition, or alternatively, the synchronization message may identify the first HFS used by the first access point AP1. For example, the PAST information may also indicate a reference HFS used by the first access point AP1, and the first HFS may be the reference HFS or an HFS that is shifted (e.g., frequency shuffled) from the reference HFS. For example, if an HFS is shifted from a reference HFS, then at all frequency instances in a frequency sequence, a channel index of the HFS may be different from a channel index of the reference HFS. In some aspects, the synchronization message may identify the first HFS used by the first access point AP1 by indicating the first index value associated with the first access point AP1 (e.g., the first HFS may be determined using the first index value and the reference HFS). For example, the synchronization message may indicate a set of index values that includes the first index value and/or one or more additional index values, associated with additional access points, known to the first access point AP1. In some aspects, the set of index values may include an index value for the second access point AP2 that indicates an HFS to be used by the second access point AP2.

The exchange of periodic advertising timing information (e.g., the exchange of PAST information) may enable the second access point AP2 to synchronize with the first access point AP1. Accordingly, in the same manner, multiple additional access points may synchronize to the same periodic advertisement timing. For example, a third access point AP3 may also synchronize with the first access point AP1, and a fourth access point AP4 may synchronize with the third access point AP3, thereby resulting in the fourth access point AP4 being synchronized with the second access point AP2 by transitive synchronization. In this way, multiple access points may become time synchronized with each other.

As shown by reference number 455, based on receiving the synchronization message, the second access point AP2 may transmit periodic advertisements (e.g., PAs 440a, 440b), such as transmissions on a data channel, synchronized with the periodic advertisement timing (e.g., the PAwMR schedule) used by the first access point AP1. In this way, periodic advertisements are transmitted concurrently by the first access point AP1 and the second access point AP2. However, the second access point AP2 may transmit the periodic advertisements according to a second HFS. The second HFS may be offset from (e.g., different from) the first HFS used by the first access point AP1 or a reference HFS. In other words, each of the access points (e.g., with physically overlapping coverage areas) may use an HFS that is different from an HFS of any of the other access points. By using different HFSs, interference among the access points may be avoided despite the access points being time synchronized. As such, for any two HFSs of different APs, the probability of selecting the same channel at the same instant of time should be low.

The second HFS may be based at least in part on a second index value (e.g., different from the first index value) associated with the second access point AP2. For example, each of the access points (e.g., with physically overlapping coverage areas) may be associated with a different index value from any of the other access points. Accordingly, based at least in part on the set of index values identified to the second access point AP2, the second access point AP2 may select the second index value to achieve an HFS (e.g., in a radio frequency range of the second access point AP2) that is orthogonal to every other HFS currently in use. In some aspects, the second HFS may be shifted relative to the first HFS or the reference HFS based at least in part on the second index value. For example, the second HFS may be determined according to Equation 1 below:

$${HFS}_{i} = ( {HFS}_{0} + {index}_{i} ) mod 37 \qquad Equation l$$

where HFS₀ is the reference HFS, HFSᵢ is the HFS being determined, and indexᵢ is the index value used to determine the HFS. Equation 1 uses a value of 37 for the modulo operation because a BLE system uses 37 data channels. However, a different value for the modulo operation may be used (e.g., corresponding to a quantity of channels) in other systems.

In some aspects, an index value may indicate an HFS in a manner other than as described above. That is, an index value may be any means to identify a hopping frequency channel (or “channel selection”) sequence. For example, each access point and each wireless communication device may be configured with a set of HFSs, and an index value may map to a particular HFS of the set of HFSs. Thus, indication of a set of index values, as described herein, may refer to the indication of all active (e.g., in use) HFSs of the set of HFSs.

In some aspects, the first access point AP1 may transmit, and one or more wireless communication devices (e.g., wireless communication devices 120 of FIG. 1) may receive, information identifying the periodic advertisement timing (e.g., PAST information) used by the first access point AP1. For example, the first access point AP1 may transmit the information in connection with onboarding the wireless communication device(s) to the first access point AP1. In some aspects, the second access point AP2 may transmit, and one or more wireless communication devices (e.g., wireless communication devices 120) may receive, information identifying the periodic advertisement timing (e.g., PAST information) used by the second access point AP2. For example, the second access point AP2 may transmit the information to wireless communication devices already onboarded with the second access point AP2, or the second access point AP2 may cause the wireless communication devices to repeat an onboarding procedure with the second access point AP2 during which the information is transmitted.

In some aspects, the first access point AP1 may transmit (e.g., via broadcast), and one or more wireless communication devices (e.g., wireless communication devices 120 of FIG. 1) synchronized to the first access point AP1 may receive, information identifying a set of (e.g., one or more) index values indicating HFSs used by one or more access points. For example, the set of index values may include the first index value associated with the first access point AP1, the second index value associated with the second access point AP2, and/or one or more additional index values, associated with additional access points, known to the first access point AP1. Similarly, in some aspects, the second access point AP2 may transmit (e.g., via broadcast), and one or more wireless communication devices (e.g., wireless communication devices 120 of FIG. 1) synchronized to the second access point AP₂ may receive, information identifying a set of (e.g., one or more) index values indicating HFSs used by one or more access points. For example, the one or more index values may include the first index value associated with the first access point AP1, the second index value associated with the second access point AP2, and/or one or more additional index values, associated with additional access points, known to the second access point AP2. In some aspects, the first access point AP1 and/or the first access point AP1 may receive, from the management entity, information indicating the index values that are in use (e.g., valid indexes) for one or more additional access points.

Over time (e.g., due to clock drift), the periodic advertisement timing used by the first access point AP1 and the second access point AP2 may become misaligned. As shown by reference number 450, the second access point AP2 may monitor (e.g., sporadically) for an additional periodic advertisement from the first access point AP1 in a monitoring opportunity. In other words, the second access point AP2 may sacrifice a periodic advertisement transmission (e.g., for a particular group of wireless communication devices) in order to monitor (e.g., listen) for the additional periodic advertisement from the first access point AP1. In some aspects, the monitoring opportunity, in which the second access point AP2 monitors for the additional periodic advertisement, may be based at least in part on an expected clock drift between the first access point AP1 and the second access point AP2. Based on a timing of the additional periodic advertisement, the periodic advertisement timing may be realigned between the first access point AP1 and the second access point AP2. For example, the second access point AP2 may realign with the periodic advertisement timing used by the first access point AP1 based at least in part on a timing of the additional periodic advertisement (e.g., based at least in part on a difference between the actual timing of the additional periodic advertisement and an expected timing of the additional periodic advertisement).

In some examples, an access point that uses a transmission timing or schedule (e.g., a periodic advertisement timing or schedule) that is followed by another access point may be referred to as a “leader access point,” and an access point that synchronizes its transmission timing or schedule to the transmission timing or schedule of another access point may be referred to as a “follower access point.” In some cases, an access point may be both a leader access point and a follower access point. For example, the transmission timing or schedule used by a first access point may be followed by a second access point, and a third access point may follow the transmission timing or schedule used by the second access point. Thus, in this example, the second access point is both a leader access point and a follower access point.

As indicated above, FIG. 4 is provided as an example. Other examples may differ from what is described with respect to FIG. 4.

As discussed above with respect to FIG. 4, in access point synchronization, when an ESL is moved from one location to another in an environment such that the ESL is out of range of its current associated access point, the ESL can identify an alternative access point within range of the ESL to associate with. The ESL can thus quickly join the PAwMR train associated with that access point. However, in a typical environment (e.g., a large retail store), the access points, positioned in various different locations around the environment, can each have a different channel map. Access points located throughout the environment may have different channel maps because, for example, different areas of the environment (e.g., different departments of the store) may utilize different RF frequency channels. A channel map can include one or more RF channels for communication with a particular access point. As such, it cannot be assumed that the deployment of a single channel map across an environment (e.g., a large retail store) will be effective for communication with all of the access points in that environment. In one or more aspects, systems and techniques provide a method to broadcast channel map information in an access point synchronization system such that all of the access points within an environment have knowledge of the particular channel maps associated with each of the access points within that environment. Once all of the access points are aware of each other's channel maps, the access points may tune to the other access points' channel maps to communicate with each other.

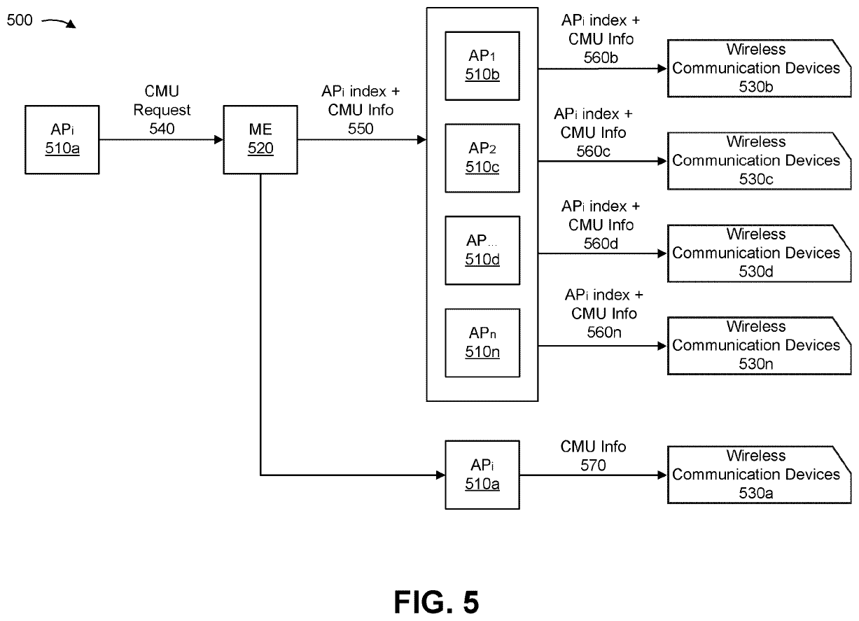

FIG. 5 is a diagram illustrating an example of a system 500 for providing (e.g., broadcasting) channel map information in an access point synchronization system. For example, communications are exchanged for updating a channel map of an access point (e.g., APᵢ 510a). As shown in FIG. 5, a plurality of access points 510a, 510b, 510c, 510d, 510n, a management entity 520, and groups of wireless communication devices 530a, 530b, 530c, 530d, 530n are shown. The access points 510a, 510b, 510c, 510d, 510n may be located in different positions in an environment (e.g., a retail store, warehouse, or global distribution center). Each group of wireless communication devices 530a, 530b, 530c, 530d, 530n may be closely located in the environment to and associated (e.g., synchronized) with one of the access points 510a, 510b, 510c, 510d, 510n.

In one or more examples, the access points 510a, 510b, 510c, 510d, 510n may be communicatively coupled to the management entity 520 wirelessly (e.g., via Wi-Fi communications) and/or via wire (e.g., Ethernet). The access points 510a, 510b, 510c, 510d, 510n may be communicatively coupled to the wireless communication devices of the groups of wireless communication devices 530a, 530b, 530c, 530d, 530n wirelessly (e.g., via Bluetooth™ communications).

In one or more examples, each of the wireless communication devices of the groups of wireless communication devices 530a, 530b, 530c, 530d, 530n may be implemented as an ESL. Each of the wireless communication devices (e.g. ESL) of the groups of wireless communication devices 530a, 530b, 530c, 530d, 530n may be located (e.g., mounted) on a shelf or on an item located within the environment (e.g., retail store).

The wireless communication devices (e.g., ESLs) of each group of wireless communication devices 530a, 530b, 530c, 530d, 530n may be synchronized with an associated access point 510a, 510b, 510c, 510d, 510n. For example, the wireless communication devices (e.g. ESLs) of the group of wireless communication devices 530a may be synchronized with APᵢ 510a, the wireless communication devices (e.g. ESLs) of the group of wireless communication devices 530b may be synchronized with AP₁ 510b, the wireless communication devices (e.g. ESLs) of the group of wireless communication devices 530c may be synchronized with AP₂ 510c, the wireless communication devices (e.g. ESLs) of the group of wireless communication devices 530d may be synchronized with AP . . . 510d, and the wireless communication devices (e.g. ESLs) of the group of wireless communication devices 530n may be synchronized with APₙ 510n.

During operation for broadcasting channel map information in an access point synchronization system, when an access point (e.g., APi 510) chooses to update its channel map, the access point (e.g., APi 510) may send (e.g., transmit) a channel map update (CMU) request 540 to a management entity 520. The channel map update request 540 may include a request that the access point's (e.g., APi 510) channel map be updated to the wireless communication devices (e.g., ESLs) of the groups of wireless communication devices 530a, 530b, 530c, 530d, 530n so that the wireless communication devices (e.g., ESLs) know which channel map to use to communicate with that particular access point (e.g., APi 510). The channel map update request 540 may also include the particular channel map for the access point (e.g., APi 510) to be used for communication with the access point (e.g., APi 510) and an instant (e.g., updateEventCounter) indicating a value (e.g., representing a time) of an event counter (e.g., EventCounter) for using the channel map for communication with the access point (e.g., APi 510). The event counter (e.g., EventCounter) can be incremented at each periodic advertising event, and can be used to synchronize link layer procedures. The channel map may include one or more RF frequency channels to be used for communication with the access point (e.g., APi 510) at a future time.

After the management entity 520 has received the channel map update request 540 from the access point (e.g., APi 510), the management entity 520 may determine channel map update information based on the information contained within the channel map update request 540. The channel map update information may include the channel map for the access point (e.g., APi 510), an index for the access point (e.g., APi 510), and/or the instant (e.g., updateEventCounter) indicating the value (e.g., representing a time) of the event counter (e.g., EventCounter) for using the channel map for communication with the access point (e.g., APi 510).

After the management entity 520 has determined the channel map update information, the management entity 520 may then send 550 (e.g., transmit) the channel map update information to all of the access points 510a, 510b, 510c, 510d, 510n in the environment (e.g., within the ESL system). In particular, the management entity 520 may then send 550 (e.g., transmit) the channel map update information, which may include the access point (e.g., APi 510) index, to access points AP₁ 510b, AP₂ 510c, AP . . . 510d, and APₙ 510n. The management entity 520 may also send (e.g., transmit) the channel map update information, which may not include the access point (e.g., APi 510) index, to the access point APᵢ 510a. The management entity 520 may not include the access point (e.g., APi 510) index with the channel map update information to the access point (e.g., APi 510) because it can be understood by the access point (e.g., APi 510) that the channel map update information is related to itself.

After the management entity 520 has sent (e.g., transmitted) the channel map update information to all of the access points 510a, 510b, 510c, 510d, 510n in the environment (e.g., within the ESL system), each of the access points 510a, 510b, 510c, 510d, 510n may transmit the channel map update information to the wireless communication devices (e.g., ESLs) in the group of wireless communication devices 530a, 530b, 530c, 530d, 530n that is associated (e.g., synchronized) with itself. For instance, each of the access points 510a, 510b, 510c, 510d, 510n may transmit the channel map update information to the wireless communication devices (e.g., ESLs) one or more times (e.g., transmit multiple consecutive times, such as six consecutive times, to ensure that every wireless communication device can receive the information). In one example, access point APi 510a may send 570 (e.g., transmit) the channel map update information, which may not include the access point (e.g., APi 510) index, to the wireless communication devices in the group of wireless communication devices 530a; access point AP₁ 510b may send 560b (e.g., transmit) the channel map update information, which may include the access point (e.g., APi 510) index, to the wireless communication devices in the group of wireless communication devices 530b; access point AP₂ 510c may send 560c (e.g., transmit) the channel map update information, which may include the access point (e.g., APi 510) index, to the wireless communication devices in the group of wireless communication devices 530c; access point AP 510d may send 560d (e.g., transmit) the channel map update information, which may include the access point (e.g., APi 510) index, to the wireless communication devices in the group of wireless communication devices 530d; and access point APₙ 510n may send 560n (e.g., transmit) the channel map update information, which may include the access point (e.g., APi 510) index, to the wireless communication devices in the group of wireless communication devices 530n. In one or more examples, the access points 510a, 510b, 510c, 510d, 510n may send (e.g., transmit) the channel map update information to the wireless communication devices (e.g., ESLs) in the group of wireless communication devices 530a, 530b, 530c, 530d, 530n via a periodic advertisement (e.g., the periodic advertisement may include the channel map update information).

After the wireless communication devices (e.g., ESLs) in the groups of wireless communication devices 530a, 530b, 530c, 530d, 530n receive the channel map update information from the access points 510a, 510b, 510c, 510d, 510n, the wireless communication devices (e.g., ESLs) in the groups of wireless communication devices 530a, 530b, 530c, 530d, 530n may compare their respective local event counter (e.g., EventCounter) with the instant, which is contained within the channel map update information, to determine when they should start to apply the channel map of the received channel map update information. When their respective local event counter is equal to the instant, the wireless communication devices (e.g., ESLs) in the groups of wireless communication devices 530a, 530b, 530c, 530d, 530n can then apply the channel map of the received channel map update information. The wireless communication devices (e.g., ESLs) in the groups of wireless communication devices 530a, 530b, 530c, 530d, 530n do not need to, but may, send (e.g., transmit) a response to the access points 510a, 510b, 510c, 510d, 510n. The wireless communication devices (e.g., ESLs) in the groups of wireless communication devices 530a, 530b, 530c, 530d, 530n can maintain a list including a description of the channel map update information for each of the access points 510a, 510b, 510c, 510d, 510n within the environment (e.g., the ESL system).

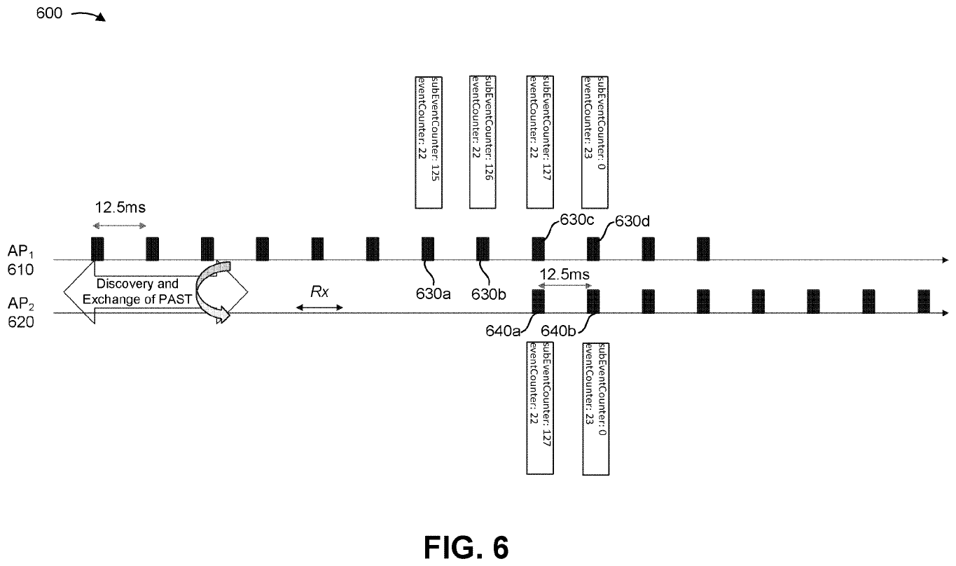

FIG. 6 is a diagram illustrating an example of transmission timelines 600 associated with synchronization of event counters (referred to as EventCounters) between access points (e.g., AP₁ 610 and AP₂ 620). In one or more examples, an event counter (e.g., EventCounter) and a subframe event counter (e.g., subframeEventCounter) may be shared by using an access point synchronization system. In one or more examples, during synchronization between access points (e.g., AP₁ 610 and AP₂ 620), the event counter (e.g., EventCounter) and a subframe event counter (e.g., subframeEventCounter) may be aligned between the periodic advertisements of the access points (e.g., AP₁ 610 and AP₂ 620). In one or more examples, wireless communication devices (e.g., ESLs), being in synchronization with the access points (e.g., AP₁ 610 and AP₂ 620), may be also have their event counter (e.g., EventCounter) and a subframe event counter (e.g., subframeEventCounter) aligned with the access points (e.g., AP₁ 610 and AP₂ 620).

In FIG. 6, access points AP₁ 610 and AP₂ 620 are shown on respective transmission timelines of the transmission timelines 600. The access points AP₁ 610 and AP₂ 620 may be communicatively connected to a management entity (e.g., management entity 130 of FIG. 1). The access points and/or the management entity can be included in a wireless communication system, such as an ESL system. The wireless communication system may use a wireless communication technology (e.g., BLE).

In one or more examples, during operation, access point AP₁ 610 can transmit (e.g., broadcast) periodic advertisements, for example in a train of periodic advertisements. The access point AP₁ 610 may transmit periodic advertisements in accordance with a PAwMR schedule. Each periodic advertisement may include an event counter (e.g., EventCounter) and a subframe event counter (e.g., subframeEventCounter). In one or more examples, each periodic advertisement may include channel map update information.

The access point AP₂ 620 may detect at least one periodic advertisement broadcast (e.g., PAs 630a, 630b) from the access point AP₁ 610 (e.g., by scanning known channels on which the access point AP₁ 610 performs transmissions and/or by scanning, or taking a snapshot of, an entire band). That is, the access point AP₂ 620 can discover the access point AP₁ 610. In some aspects, the access point AP₂ 620 can listen on one or more advertisement channels (e.g., legacy advertisement channels) to detect information that enables the access point AP₂ 620 to follow and synchronize with the access point AP₁ 610, thereby enabling the access point AP₂ 620 to monitor for the periodic advertisement(s).

Based on detecting a periodic advertisement from the access point AP₁ 610, the access point AP₂ 620 may transmit, and the access point AP₁ 610 may receive, a message (e.g., an unsolicited message) to initiate a connection between the access point AP₁ 610 and the access point AP₂ 620. Following the connection, or as part of the connection procedure, the access point AP₁ 610 may transmit, and the access point AP₂ 620 may receive, a synchronization message. The synchronization message may identify the periodic advertisement timing (e.g., the PawMR schedule) used by the access point AP₁ 610.

For example, the synchronization message may include PAST information that indicates the periodic advertising timing used by the access point AP₁ 610 (e.g., by indicating a time offset used by the access point AP₁ 610). The synchronization message may include event counter (e.g., EventCounter) information and subframe event counter (e.g., subframeEventCounter) information for the periodic advertising timing used by the access point AP₁ 610. The exchange of periodic advertising timing information (e.g., the exchange of PAST information), event counter information, and subframe event counter information can enable the access point AP₂ 620 to synchronize its periodic advertisements with the periodic advertisements of access point AP₁ 610 such that the event counter and subframe event counters of the periodic advertisements of access point AP₁ 610 and the periodic advertisements of access point AP₂ 620 are aligned. For example, periodic advertisement PA 630a of access point AP₁ 610 has an event counter of 22 and a subframe event counter of 125, periodic advertisement PA 630b of access point AP₁ 610 has an event counter of 22 and a subframe event counter of 126, periodic advertisement PA 630c of access point AP₁ 610 has an event counter of 22 and a subframe event counter of 127, and periodic advertisement PA 630d of access point AP₁ 610 has an event counter of 23 and a subframe event counter of 0. Access point AP₂ 620 may synchronize to the periodic advertisement train used by access point AP₁ 610 such that periodic advertisement PA 640a of access point AP₂ 620 has an event counter of 22 and a subframe event counter of 127 (e.g., which is similar to periodic advertisement 630c of access point AP₁ 610 transmitted at the same time), and periodic advertisement PA 640b of access point AP₂ 620 has an event counter of 23 and a subframe event counter of 0 (e.g., which is similar to periodic advertisement 630d of access point AP₁ 610 transmitted at the same time).

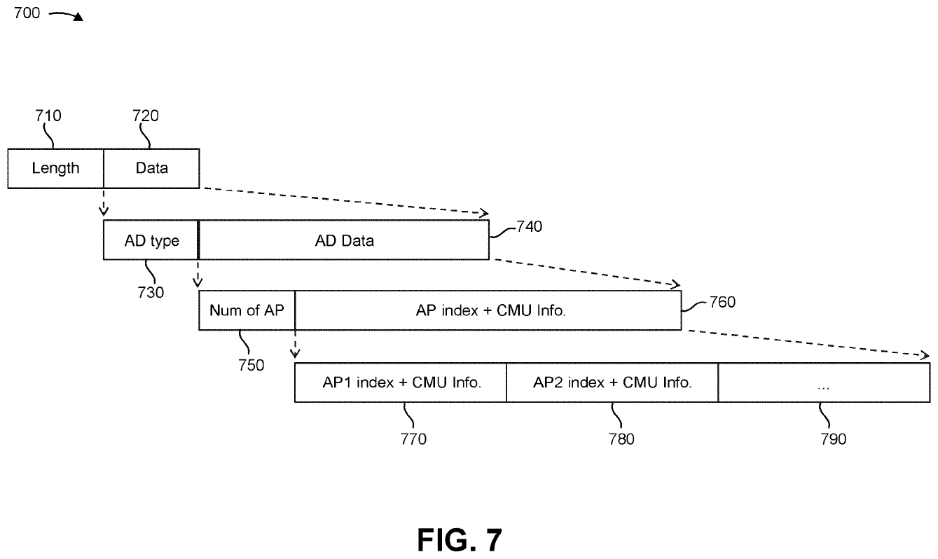

FIG. 7 is a diagram illustrating an example of a portion of a periodic advertisement (PA) packet 700. As previously mentioned, access points, such as access points 510a, 510b, 510c, 510d, 510n of FIG. 5, may transmit periodic advertisements (PAs) that include channel map update information (e.g., as well as may include the index for the access point associated with the channel map update information) to wireless electronic devices (e.g., ESLs), such as the wireless communication devices in the groups of wireless communication devices 530a, 530b, 530c, 530d, 530n of FIG. 5.

In one or more examples, the channel map update information may be incorporated into a portion of a periodic advertisement packet 700 as illustrated in FIG. 7. In particular, the channel map update information may be incorporated into an additional controller advertising data (ACAD) portion of the periodic advertisement packet 700.

In FIG. 7, the ACAD portion of the periodic advertisement packet 700 may include a plurality of sections including, but not limited to, a length section 710 and a data section 720. The data section 720 may include an advertising data (AD) type section 730 and an advertising data section 740. The advertising data section 740 may include an access point number section 750 and an access point index and channel map update information section 760. The access point index and channel map update information section 760 may include specific access point sections including channel map update information for that specific access point (e.g., an access point 1 index and channel map update information section 770, an access point 2 index and channel map update information section 780, etc.). FIG. 7 is provided as one example for the incorporation of the channel map update information into a periodic advertisement packet. Other examples may differ from what is described with respect to FIG. 7.

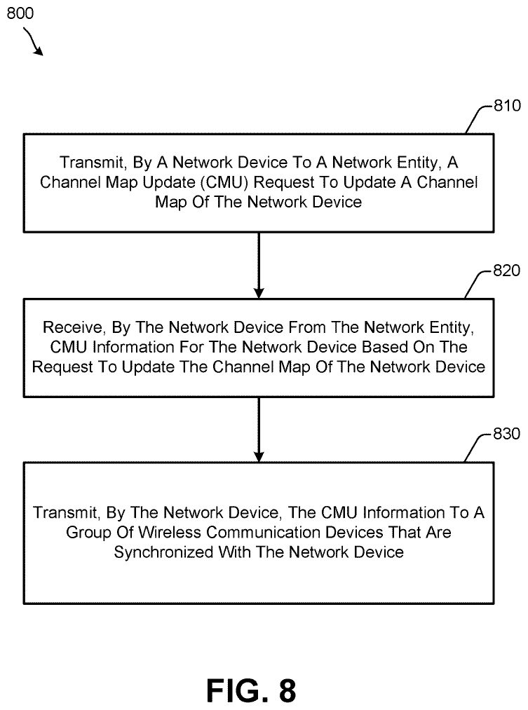

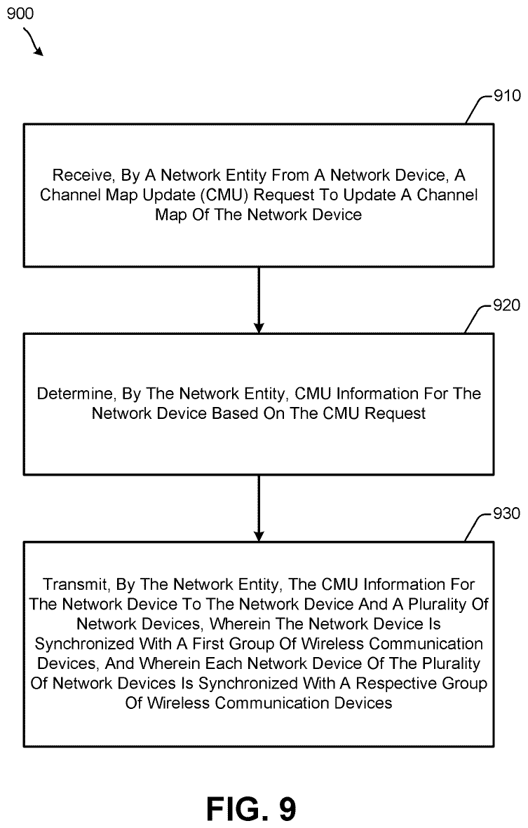

FIG. 8 is a flow chart illustrating an example of a process 800 for wireless communications utilizing methods for a CMU in an AP synchronization system. The process 800 can be performed by a network device (e.g., an AP, such as the APᵢ 510a of FIG. 5) or by a component or system (e.g., a chipset) of the network device. The operations of the process 800 may be implemented as software components that are executed and run on one or more processors (e.g., processor 910 of FIG. 9 or other processor(s)). Further, the transmission and reception of signals by the wireless communications device in the process 800 may be enabled, for example, by one or more antennas and/or one or more transceivers (e.g., wireless transceiver(s)).

At block 810, the network device (or component thereof) can transmit (e.g., using the communication component 235 of FIG. 2), to a network entity, a channel map update (CMU) request to update a channel map of the network device. In some examples, the network entity is a management entity (ME) (e.g., the ME 520 of FIG. 5). As described herein, the CMU request can include the channel map for the network device and an instant indicating a value of an event counter (e.g., the EventCounter described above) for applying the channel map. In some cases, the channel map includes at least one channel for communication with the network device. For instance, as described herein, the channel map may include a listing of frequency channels to be utilized or, conversely, not to be utilized (e.g., in the context of modification of frequency hopping sequences) by the network device for communication.

At block 820, the network device (or component thereof) can receive (e.g., using the communication component 235 of FIG. 2), from the network entity, CMU information for the network device based on the CMU request to update the channel map of the network device. In some aspects, the CMU information includes the channel map for the network device. In some cases, the CMU information further includes an index for the network device. Additionally or alternatively, in some cases, CMU information includes an instant indicating a value of an event counter (e.g., the EventCounter described above) for using the channel map for communication with the network device.

At block 830, the network device (or component thereof) can transmit (e.g., using the communication component 235 of FIG. 2) the CMU information to a group of wireless communication devices that are synchronized with the network device (e.g., the wireless communication devices 530a of FIG. 5). In one illustrative example, each wireless communication device in the group of wireless communication devices is an electronic shelf label (ESL).

In some aspects, to transmit the CMU information to the group of wireless communication devices, the network device (or component thereof) can transmit (e.g., using the communication component 235 of FIG. 2) a periodic advertisement (PA) including the CMU information to the group of wireless communication devices. In one illustrative example, the CMU information is within an additional controller advertising data (ACAD) portion of the PA. In some cases, the ACAD portion of the PA further includes advertising data (AD).

In some aspects, the network device (or component thereof) can receive (e.g., using the communication component 235 of FIG. 2) at least one response from at least one wireless communication devices of the group of wireless communication devices that is synchronized with the network device.

FIG. 9 is a flow chart illustrating an example of a process 900 for wireless communications utilizing methods for a CMU in an AP synchronization system. The process 900 can be performed by a network entity (e.g., an ME, such as the ME 520 of FIG. 5) or by a component or system (e.g., a chipset) of the network entity. The operations of the process 900 may be implemented as software components that are executed and run on one or more processors (e.g., processor 910 of FIG. 9 or other processor(s)). Further, the transmission and reception of signals by the wireless communications device in the process 900 may be enabled, for example, by one or more antennas and/or one or more transceivers (e.g., wireless transceiver(s)).

At block 910, the network entity (or component thereof) can receive (e.g., using the communication component 235 of FIG. 2), from a network device, a channel map update (CMU) request to update a channel map of the network device. In some cases, the network device is an access point (AP) (e.g., the APᵢ 510a of FIG. 5). As described herein, the CMU request can include the channel map for the network device and an instant indicating a value of an event counter (e.g., the EventCounter described above) for applying the channel map. In some cases, the channel map includes at least one channel for communication with the network device. For instance, as described herein, the channel map may include a listing of frequency channels to be utilized or, conversely, not to be utilized (e.g., in the context of modification of frequency hopping sequences) by the network device for communication.

At block 920, the network entity (or component thereof) can determine (e.g., using the processor 235 of FIG. 2) CMU information for the network device based on the CMU request. In some aspects, the CMU information includes the channel map for the network device. In some cases, the CMU information further includes an index for the network device. Additionally or alternatively, in some cases, CMU information includes an instant indicating a value of an event counter (e.g., the EventCounter described above) for using the channel map for communication with the network device.

At block 930, the network entity (or component thereof) can transmit (e.g., using the communication component 235 of FIG. 2) the CMU information for the network device to the network device and a plurality of network devices. In some cases, the plurality of network devices are a plurality of APs. The network device is synchronized with a first group of wireless communication devices, and each network device of the plurality of network devices is synchronized with a respective group of wireless communication devices. In one illustrative example, each wireless communication device in the respective group of wireless communication devices is an electronic shelf label (ESL).

The first network device may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the network device configured to perform the process 800 of FIG. 8 and/or the network entity configured to perform the process 900 of FIG. 9 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 800 and the process 900 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800, process 900, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

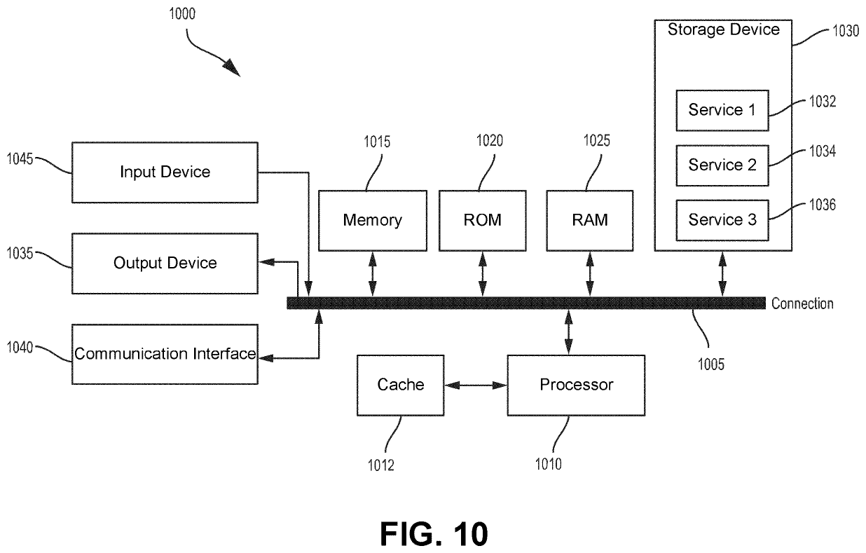

FIG. 10 is a block diagram illustrating an example of a computing system 1000, which may be employed by the disclosed systems and techniques for a CMU in an AP synchronization system. In particular, FIG. 10 illustrates an example of computing system 1000, which can be, for example, any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LIDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1. A network device for wireless communication, the network device comprising: at least one memory; and at least one processor coupled to the at least one memory and configured to: output, for transmission to a network entity, a channel map update (CMU) request to update a channel map of the network device; receive, from the network entity, CMU information for the network device based on the CMU request to update the channel map of the network device; and output the CMU information for transmission to a group of wireless communication devices that are synchronized with the network device.

Aspect 2. The network device of Aspect 1, wherein the network device is an access point (AP).

Aspect 3. The network device of any one of Aspects 1 or 2, wherein the network entity is a management entity (ME).

Aspect 4. The network device of any one of Aspects 1 to 3, wherein each wireless communication device in the group of wireless communication devices is an electronic shelf label (ESL).

Aspect 5. The network device of any one of Aspects 1 to 4, wherein the CMU request comprises the channel map for the network device and an instant indicating a value of an event counter for applying the channel map.

Aspect 6. The network device of any one of Aspects 1 to 5, wherein the channel map comprises at least one channel for communication with the network device.

Aspect 7. The network device of any one of Aspects 1 to 6, wherein the CMU information comprises the channel map for the network device.

Aspect 8. The network device of Aspect 7, wherein the CMU information further comprises an index for the network device.

Aspect 9. The network device of any one of Aspects 7 or 8, wherein the CMU information further comprises an instant indicating a value of an event counter for using the channel map for communication with the network device.

Aspect 10. The network device of any one of Aspects 1 to 9, wherein, to output the CMU information for transmission to the group of wireless communication devices, the at least one processor is configured to output a periodic advertisement (PA) comprising the CMU information for transmission to the group of wireless communication devices.

Aspect 11. The network device of Aspect 10, wherein the CMU information is within an additional controller advertising data (ACAD) portion of the PA.

Aspect 12. The network device of Aspect 11, wherein the ACAD portion of the PA further comprises advertising data (AD).

Aspect 13. The network device of any one of Aspects 1 to 12, wherein the at least one processor is configured to receive at least one response from at least one wireless communication devices of the group of wireless communication devices that is synchronized with the network device.

Aspect 14. A method of wireless communication performed at a network device, the method comprising: transmitting, by the network device to a network entity, a channel map update (CMU) request to update a channel map of the network device; receiving, by the network device from the network entity, CMU information for the network device based on the CMU request to update the channel map of the network device; and transmitting, by the network device, the CMU information to a group of wireless communication devices that are synchronized with the network device.

Aspect 15. The method of Aspect 14, wherein the network device is an access point (AP).

Aspect 16. The method of any one of Aspects 14 or 15, wherein the network entity is a management entity (ME).

Aspect 17. The method of any one of Aspects 14 to 16, wherein each wireless communication device in the group of wireless communication devices is an electronic shelf label (ESL).

Aspect 18. The method of any one of Aspects 14 to 17, wherein the CMU request comprises the channel map for the network device and an instant indicating a value of an event counter for applying the channel map.

Aspect 19. The method of any one of Aspects 14 to 18, wherein the channel map comprises at least one channel for communication with the network device.

Aspect 20. The method of any one of Aspects 14 to 19, wherein the CMU information comprises the channel map for the network device.

Aspect 21. The method of Aspect 20, wherein the CMU information further comprises an index for the network device.

Aspect 22. The method of any one of Aspects 20 or 21, wherein the CMU information further comprises an instant indicating a value of an event counter for using the channel map for communication with the network device.

Aspect 23. The method of any one of Aspects 14 to 22, wherein transmitting the CMU information comprises transmitting a periodic advertisement (PA) comprising the CMU information.

Aspect 24. The method of Aspect 23, wherein the CMU information is within an additional controller advertising data (ACAD) portion of the PA.

Aspect 25. The method of Aspect 24, wherein the ACAD portion of the PA further comprises advertising data (AD).

Aspect 26. The method of any one of Aspects 14 to 25, further comprising receiving, by the network device, at least one response from at least one wireless communication devices of the group of wireless communication devices that is synchronized with the network device.

Aspect 27. A network entity for wireless communication performed, the network entity comprising: at least one memory; and at least one processor coupled to the at least one memory and configured to: receive, from a network device, a channel map update (CMU) request to update a channel map of the network device; determine CMU information for the network device based on the CMU request; and output the CMU information for the network device for transmission to the network device and a plurality of network devices, wherein the network device is synchronized with a first group of wireless communication devices, and wherein each network device of the plurality of network devices is synchronized with a respective group of wireless communication devices.

Aspect 28. The network entity of Aspect 27, wherein the network device is an access point (AP) and wherein the plurality of network devices are a plurality of APs.

Aspect 29. The network entity of any one of Aspects 27 or 28, wherein the network entity is a management entity (ME).

Aspect 30. The network entity of any one of Aspects 27 to 29, wherein each wireless communication device of the respective group of wireless communication devices is an electronic shelf label (ESL).

Aspect 31. The network entity of any one of Aspects 27 to 30, wherein the CMU request comprises the channel map for the network device and an instant indicating a value of an event counter for applying the channel map.

Aspect 32. The network entity of any one of Aspects 27 to 31, wherein the channel map comprises at least one channel for communication with the network device.

Aspect 33. The network entity of any one of Aspects 27 to 32, wherein the CMU information comprises the channel map for the network device.

Aspect 34. The network entity of Aspect 33, wherein the CMU information further comprises an index for the network device.

Aspect 35. The network entity of any one of Aspects 33 or 34, wherein the CMU information further comprises an instant indicating a value of an event counter for using the channel map for communication with the network device.

Aspect 36. A method of wireless communication performed at a network entity, the method comprising: receiving, by the network entity from a network device, a channel map update (CMU) request to update a channel map of the network device; determining, by the network entity, CMU information for the network device based on the CMU request; and transmitting, by the network entity, the CMU information for the network device to the network device and a plurality of network devices, wherein the network device is synchronized with a first group of wireless communication devices, and wherein each network device of the plurality of network devices is synchronized with a respective group of wireless communication devices.

Aspect 37. The method of Aspect 36, wherein the network device is an access point (AP) and wherein the plurality of network devices are a plurality of APs.

Aspect 38. The method of any one of Aspects 36 or 37, wherein the network entity is a management entity (ME).

Aspect 39. The method of any one of Aspects 36 to 38, wherein each wireless communication device of the respective group of wireless communication devices is an electronic shelf label (ESL).

Aspect 40. The method of any one of Aspects 36 to 39, wherein the CMU request comprises the channel map for the network device and an instant indicating a value of an event counter for applying the channel map.

Aspect 41. The method of any one of Aspects 36 to 40, wherein the channel map comprises at least one channel for communication with the network device.

Aspect 42. The method of any one of Aspects 36 to 41, wherein the CMU information comprises the channel map for the network device.

Aspect 43. The method of Aspect 42, wherein the CMU information further comprises an index for the network device.

Aspect 44. The method of any one of Aspects 42 or 43, wherein the CMU information further comprises an instant indicating a value of an event counter for using the channel map for communication with the network device.

Aspect 45. A non-transitory computer-readable medium including instructions that, when executed by at least one processor, cause the at least one processor to perform operations according to any of Aspects 14 to 26.

Aspect 46. An apparatus for wireless communication, the apparatus comprising one or more means for performing operations according to any of Aspects 14 to 26.

Aspect 47. A non-transitory computer-readable medium including instructions that, when executed by at least one processor, cause the at least one processor to perform operations according to any of Aspects 36 to 44.

Aspect 48. An apparatus for wireless communication, the apparatus comprising one or more means for performing operations according to any of Aspects 36 to 44.

Aspect 49. A non-transitory computer-readable medium including instructions that, when executed by at least one processor, cause the at least one processor to perform operations according to any of Aspects 14 to 26 and Aspects 36 to 44.

Aspect 50. An apparatus for wireless communication, the apparatus comprising one or more means for performing operations according to any of Aspects 14 to 26 and Aspects 36 to 44.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

1. A network device for wireless communication, the network device comprising:
at least one memory; and
at least one processor coupled to the at least one memory and configured to:
output, for transmission to a network entity, a channel map update (CMU) request to update a channel map of the network device;
receive, from the network entity, CMU information for the network device based on the CMU request to update the channel map of the network device; and
output the CMU information for transmission to a group of wireless communication devices that are synchronized with the network device.

2. The network device of claim 1, wherein the network device is an access point (AP).

3. The network device of claim 1, wherein the network entity is a management entity (ME).

4. The network device of claim 1, wherein each wireless communication device in the group of wireless communication devices is an electronic shelf label (ESL).

5. The network device of claim 1, wherein the CMU request comprises the channel map for the network device and an instant indicating a value of an event counter for applying the channel map.

6. The network device of claim 1, wherein the channel map comprises at least one channel for communication with the network device.

7. The network device of claim 1, wherein the CMU information comprises the channel map for the network device.

8. The network device of claim 7, wherein the CMU information further comprises an index for the network device.

9. The network device of claim 7, wherein the CMU information further comprises an instant indicating a value of an event counter for using the channel map for communication with the network device.

10. The network device of claim 1, wherein, to output the CMU information for transmission to the group of wireless communication devices, the at least one processor is configured to output a periodic advertisement (PA) comprising the CMU information for transmission to the group of wireless communication devices.

11. The network device of claim 10, wherein the CMU information is within an additional controller advertising data (ACAD) portion of the PA.

12. The network device of claim 11, wherein the ACAD portion of the PA further comprises advertising data (AD).

13. The network device of claim 1, wherein the at least one processor is configured to receive at least one response from at least one wireless communication devices of the group of wireless communication devices that is synchronized with the network device.

14. A method of wireless communication performed at a network device, the method comprising:
transmitting, by the network device to a network entity, a channel map update (CMU) request to update a channel map of the network device;
receiving, by the network device from the network entity, CMU information for the network device based on the CMU request to update the channel map of the network device; and
transmitting, by the network device, the CMU information to a group of wireless communication devices that are synchronized with the network device.

15. The method of claim 14, wherein the network device is an access point (AP).

16. The method of claim 14, wherein the network entity is a management entity (ME).

17. The method of claim 14, wherein each wireless communication device in the group of wireless communication devices is an electronic shelf label (ESL).

18. The method of claim 14, wherein the CMU request comprises the channel map for the network device and an instant indicating a value of an event counter for applying the channel map.

19. The method of claim 14, wherein the channel map comprises at least one channel for communication with the network device.

20. The method of claim 14, wherein the CMU information comprises the channel map for the network device.

21-30. (canceled)
